(19) United States
(12) Patent Application Publication
(10) Pub. No.: US 2011/0064216 A1
(43) Pub. Date: Mar. 17, 2011

(54) CRYPTOGRAPHIC MESSAGE SIGNATURE METHOD HAVING STRENGTHENED SECURITY, SIGNATURE VERIFICATION METHOD, AND CORRESPONDING DEVICES AND COMPUTER PROGRAM PRODUCTS

(75) Inventors: David Naccache, Paris (FR); Pavel Polechtchouk, Pateaux (FR); David Pointcheval, Thiais (FR)

(73) Assignee: Compagnie Industrielle et Financiere D'Ingenierie Ingenico, Neuilly Sur Seine (FR)

(21) Appl. No.: 12/882,838

(22) Filed: Sep. 15, 2010

(30) Foreign Application Priority Data
Sep. 15, 2009 (FR) 0956338

(51) Int. Cl. H04L 9/30

(52) U.S. Cl. 380/44; 380/28

(57) ABSTRACT

A cryptographic message signature method are provided, which have strengthened security. The method implements two sets of signature algorithms SA1={K1, S1, V1} and SA2={K2, S2, V2}, where Ki, Si and Vi are key generation algorithms, signature generation algorithms and signature verification algorithms, respectively. The method includes: a step of generating permanent keys using the algorithm K1, delivering a pair of private and public keys {sk1, pk1}; and, for at least one message m to be signed: a signature step including sub-steps. The sub-steps include: receipt of the message m to be signed; generation of an ephemeral key pair {sk2,pk2} using the algorithm K2; calculation, by the signature algorithm S2, of the signature s2 of the message m by the private key sk2; calculation, by the signature algorithm S1, of the signature c1 of the public key pk2 by the private key sk1; and providing the strengthened signature {s2, c1, pk2}.

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of digital message signature systems, and in particular cryptographic systems of the “public key digital signature” type.

More particularly, the disclosure applies to the securement of digital signatures, in particular against attacks intended to counterfeit same.

### BACKGROUND OF THE DISCLOSURE

### 1. Public Key Digital Signature Systems

Digital message signature systems are based on the use of a pair of asymmetric keys, comprising a public verification key pk and a private or secret signature key sk.

Such systems conventionally include a signature device (for example, a payment card) and a verification device (for example, a payment terminal). The signature of a message can only be generated by the signature device, the only one to possess the sk. On the other hand, verification of the digital signature can be carried out by any device, the public key used for verification being, by definition, known to everyone.

More precisely, a digital signature system includes three devices {K, S, V}, implementing a key generation algorithm for the key generation device K, a signature algorithm for the signature device S and a signature verification algorithm for the verification device V, respectively.

Hereinafter, this set of algorithms is generically referred to as a set of signature algorithms.

The key generation device K enables pairs of keys {pk, sk} to be generated, such that the public key is mathematically linked to the secret key sk.

The signature device S has two inputs corresponding, on the one hand, to the message to be signed m and, on the other hand, to the secret key sk, and one output corresponding to the signature of the message m, referenced as s=S(m,sk), which is generated by means of the secret key sk.

The verification device V has three inputs, corresponding to the signed message m, the signature s generated by the signature device and the public key pk, and one binary output b=V(m,s,pk) (b assuming the value “true” or the value “false”). b corresponds to a validation or non-validation of the signature s of the message m by means of the public key pk.

Such signature systems are used in particular in the securement of information systems and electronic transactions.

### 2. Attacks Against the Security of Digital Signature Systems

The security of digital signature systems, as described above, is a significant concern of the providers of such systems, the latter of which can be used, for example, for securing bank transactions, access control or telecommunications, and which therefore must have a maximum level of security, in particular in the face of attackers who might seek to counterfeit digital signatures produced by such systems.

A counterfeit is a pair (m′,s′) which, although produced by an entity other than the signature device S (thus not having an sk), is accepted by the verification device V.

Conventionally, a counterfeiting attack against a digital signature system consists in providing the signature device S with a large number of messages to be signed (signature requests) and in observing each signature generated prior to submitting the next message to be signed to the signature device S, so as to acquire the ability to counterfeit, i.e., imitate (perfectly or partially) the operation of the signature device.

When successful, such attacks therefore enable valid counterfeits of certain messages to be obtained, without necessarily submitting these messages to the signature device S.

A traditional technique for evaluating the security of a digital signature system consists in limiting (estimating) the number of signature requests required by the attacker before acquiring the ability to counterfeit, i.e., to generate signatures without the aid of the lawful signatory.

The conventional manner of strengthening the security of digital signature systems consists in increasing the mathematical complexity of the algorithms used in the signature devices, so as to render same more resistant to a very large number of signature requests made by an attacker.

One disadvantage of this technique lies in the fact that contemporary signature algorithms are therefore more complicated to design and execute, thereby rendering this digital signature securement approach costly to implement, in terms of time and electronic components.

### SUMMARY

An embodiment of the disclosure proposes a novel solution which does not have all of these disadvantages of the prior art, and which is in the form of a cryptographic signature method having strengthened security.

According to an exemplary embodiment, this signature method having strengthened security implements two sets of signature algorithms SA1={K1, S1, V1} and SA2={K2, S2, V2}, where Ki, Si and Vi are key generation algorithms, signature generation algorithms and signature verification algorithms, respectively, and “i” is an index having a range of values from 1 to 2, for example, and includes:
a step of generating permanent keys using the algorithm K1, delivering a pair of private and public keys {sk1, pk1};

and, for at least one message m to be signed:
a signature step including the following sub-steps:
   receipt of said message m to be signed;
   generation of an ephemeral key pair {sk2,pk2} using the algorithm K2;
   calculation, by means of the signature algorithm S2, of the signature s2 of the message m by means of the private key sk2;
   calculation, by means of the signature algorithm S1, of the signature c1 of the public key pk2 by means of the private key sk1;
   providing of the strengthened signature {s2, c1, pk2}.

An embodiment of the disclosure is thus based on a novel and inventive approach to the securement of cryptographic message signature systems, and in particular systems using a pair of asymmetric keys implementing an ephemeral asymmetric key pair making it possible to not provide information about the secret key sk1.

According to one embodiment of the disclosure, said signature step is implemented for each message m to be signed, or periodically according to a desired level of security.

Thus, if the desired level of security is very high, the method according to this embodiment enables the ephemeral key pair {sk2,pk2} to be generated for each message m to be signed, so that the ephemeral secret key is used only once and is not re-used to sign another message.

In this way, a potential attacker who might seek to counterfeit signatures produced by such a system, by submitting messages to be signed, referred to as signature requests, and by observing the signatures generated, would not be able to influence the system by taking advantage of these successive signature requests, because, for each message to be signed, a new ephemeral key pair is generated. No inference can exist between two successive signatures. Such attacks are therefore rendered ineffectual.

If the level of security is lower, the generation of the ephemeral pair key {sk2, pk2} can occur periodically, e.g., every n messages m to be signed. This embodiment is less costly in terms of key generation and offers strengthened security insofar as a single ephemeral secret key is used for only a limited number of times, thereby not allowing a potential attacker to influence the system by taking advantage of successive signature requests.

According to one embodiment of the disclosure, said signature algorithm S2 implements a hash function H and said providing step likewise provides at least one random number r, which is used by said hash function H.

This enables security to be further strengthened by implementing a hash function for the message signature.

According to one particular aspect of the disclosure, the algorithms K1 and K2, S1 and S2 and/or V1 and V2 are identical in pairs.

According to one embodiment of the disclosure, SA1 and/or SA2 include algorithms of the RSA type (for “Rivest Shamir Adleman”).

According to another embodiment of the disclosure, SA1 and/or SA2 include algorithms of the DSA type (for “Digital Signature Algorithm”).

According to one particular aspect of the disclosure, the signature method likewise includes a step of generating a pair of public and secret keys {skh, pkh} by means of a generation algorithm Kh implemented by one of the verification algorithms Vi, and said signature step implements a hash function H, known by the verification algorithms Vi, such that h=Hpkh(m; r), where r is a random number. Said strengthened signature corresponds to the triplet (S2(h), c1, pk2).

In particular, said hash function is of the “chameleon” type.

Implementing these keys {skh, pkh} by means of a generation algorithm Kh and the use of the hash function H enables the security of the signature to be further strengthened.

The disclosure likewise relates to a cryptographic message signature verification method having strengthened security, which implements two signature verification algorithms V1 and V2, and includes a joint verification phase for signatures generated according to the cryptographic message signature method having strengthened security according to claim 1, said verification phase including the following steps for a signed message m to be verified:
receipt of a strengthened signature triplet {s2, c1, pk2};
verification, using a verification algorithm V2 and a public key pk2, of the signature s2 of the message m, thereby delivering a first positive or negative result;
verification, using a verification algorithm V1 and a public key pk1, of the signature c1 of the public key pk2, thereby delivering a second positive or negative result;
delivering a positive result if the first and second results are positive.

Thus, after receipt of a signature generated by the signature method described above, in the form of a strengthened signature triplet, the verification method according to an exemplary embodiment of the disclosure must implement two verifications before validating or not validating the signature of the message m.

According to one embodiment of the disclosure, said receiving step further includes the receipt of at least one random number r.

As a matter of fact, when the signature method implements a hash function, as described above, a random number r is used for the signature and is likewise required for verifying the signature.

Another aspect of the disclosure relates to a cryptographic message signature device having strengthened security, which implements two sets of signature algorithms SA1={K1, S1, V1} and SA2={K2, S2, V2}, where Ki, Si and Vi are key generation algorithms, signature generation algorithms and signature verification algorithms, respectively, thereby delivering a pair of private and public keys {sk1, pk1}. According to an exemplary embodiment of the disclosure, for at least one message m to be signed, n such method likewise implements signature means including:
means of receiving of said message m to be signed;
means of generating of an ephemeral key pair {sk2,pk2} using the algorithm K2;
means of calculating, by means of the signature algorithm S2, the signature s2 of the message m by means of the private key sk2;
means of calculating, by means of the signature algorithm S1, the signature c1 of the public key pk2 by means of the private key sk1;
means of providing the strengthened signature {s2, c1, pk2}.

Such a device is in particular capable of implementing the steps of the signature method as described above. Such a signature device is, for example, a payment card.

The disclosure likewise relates to a cryptographic message signature verification device having strengthened security, which implements two signature verification algorithms V1 and V2, and joint verification means for signatures generated by the cryptographic message signature device having strengthened security, as described above.

According to an exemplary embodiment of the disclosure, for a signed message m to be verified, said verification means implement:
means of receiving a strengthened signature triplet {s2, c1, pk2};
means of verifying the signature s2 of the message m, using a verification algorithm V2 and a public key pk2, thereby delivering a first positive or negative result;
means of verifying the signature c1 of the public key pk2, using a verification algorithm V1 and a public key pk1, thereby delivering a second positive or negative result;
means of delivering a positive result if the first and second results are positive.

Such a verification device is, in particular, capable of implementing the steps of the verification method as described above. Such a verification device can be a payment terminal.

The disclosure likewise further relates to a cryptographic message signature verification system having strengthened security, including a cryptographic signature device and a cryptographic signature verification device as described above.

Finally, the disclosure relates to a computer program product downloadable from a communication network and/or recorded on a computer readable medium and/or executable by a processor, including program code instructions for implementing the cryptographic signature method as described above, as well as a computer program product downloadable from a communication network and/or recorded on a computer readable medium and/or executable by a processor, characterised in that it includes program code instructions for implementing the cryptographic message signature verification method having strengthened security as described above.

### BRIEF DESCRIPTION OF THE DRAWINGS

Other characteristics and advantages will become more apparent upon reading the following description of one particular embodiment, given for purely illustrative and non-limiting purposes, and from the appended drawings, in which:

FIG. 1 shows the principal steps of the cryptographic signature method according to one particular embodiment of the disclosure;

FIG. 2 shows the principal steps of the verification method for cryptographic signatures generated according to the method of FIG. 1, according to one particular embodiment of the disclosure;

FIG. 3 shows an exemplary system, according to one particular embodiment of the disclosure;

FIG. 4 shows an exemplary embodiment of the disclosure;

FIGS. 5 and 6 show the structure of a signature device and of a verification device, respectively, which implement the signature and verification techniques, respectively, according to one embodiment of the disclosure.

### DETAILED DESCRIPTION OF ILLUSTRATIVE EMBODIMENTS

### 1. General Principle

The general principle of an exemplary aspect of the disclosure is based on the implementation, in a digital message signature system, of a pair of ephemeral asymmetric keys {sk2, pk2}, in addition to a pair of permanent asymmetric keys {sk1, pk1} conventionally used for the signature of each message, and for the purpose of strengthening the security of such a signature system.

According to one embodiment of the disclosure, shown in FIG. 3, such a signature system includes a key generation KK device 30, a signature SS or signatory SS device 31, and a verification VV device 32.

Thus, for each message m to be signed, an ephemeral public key pk2 and an ephemeral private key sk2 are generated by the key generation KK device, using an algorithm K2. The private key sk2 is used by a signature algorithm S2 of the signatory SS, in order to sign the message m and to produce a signature S2=S2(m, sk2).

Immediately after calculating the signature s2, the ephemeral key sk2 is erased. A pair of ephemeral keys {sk2, pk2} is therefore used only one time and the algorithm K2 generates, on the fly, as many pairs {sk2, pk2} as there are messages submitted for signature.

The signatory SS likewise calculates the certificate c1=S1(pk2, sk1), by signing pk2 with its permanent key sk1.

The signature, called a strengthened signature, comprises three elements: c1, pk2 and s2.

The recipient of the signature (the verification device VV) verifies that V2(m, s2, pk2)=true and that V1(pk2, c1, pk1)=true, using the verification algorithms V1 and V2.

The improved security results from two observations:
an ephemeral key pair is used only once and cannot therefore be the subject of multiple signature requests by an attacker;
the permanent secret key sk1 is only used to sign pk2, a data item which is not under the control of the possible attacker.

Thus, using two sets of conventional signature algorithms {K1, S1, V1} and {K2, S2, V2}, the method according to this embodiment of the disclosure makes it possible to construct a new set of strengthened digital signature algorithms {KK, SS, VV}.

As will be apparent to a person skilled in the art, a very large combination of algorithm choices is possible for {K1, S1, V1} and {K2, S2, V2}. In addition, as already indicated, nothing excludes the choice of K1=K2, S1=S2, and V1=V2.

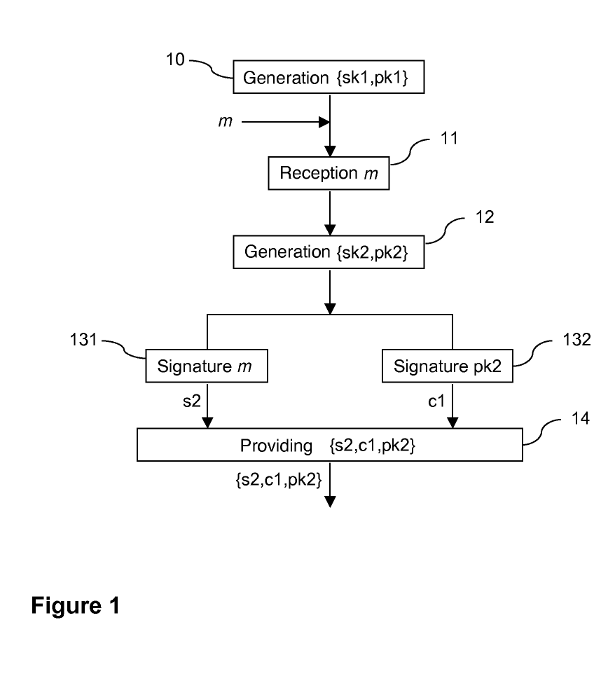

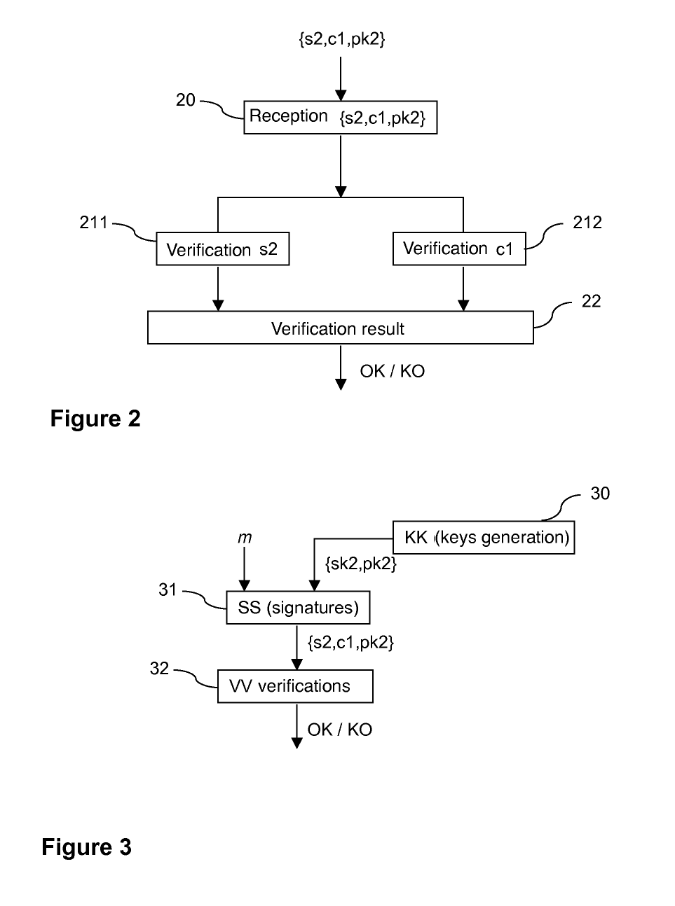

FIGS. 1 and 2 show this embodiment of the disclosure in greater detail, for the signature method and the signature verification method, respectively.

In a first phase, during a key generation step 10, the algorithm K1 generates a permanent asymmetric key pair {sk1, pk1}.

After a step 11 of receiving a message m to be signed, the algorithm K2 generates a pair of ephemeral asymmetric keys {sk2, pk2}, during a generation step 12.

The signatory SS then implements a signature algorithm S2, during a step 131, which calculates the signature s2 of the message m, such that s2=S2(m, sk2) and a signature algorithm S1, which, during a step 132, calculates the certificate c1=S1(pk2, sk1), while signing pk2 using the permanent key sk1.

Finally, during a providing step 14, the strengthened signature {c1, pk2, s2} is delivered, with a view to verification.

This strengthened signature is thus received, during a receiving step 20, by the verification device, which implements the verification algorithms V1 and V2 in order to deliver a positive or negative verification result, thereby validating or not validating the strengthened signature received.

During the verification steps 211 and 212, the signatures s2 and c1 are verified, i.e., the algorithms V2 and V1 verify that V2(m, s2, pk2)=true and that V1(pk2, c1, pk1)=true, respectively.

If these two results are true, then the verification result 22 is “OK”. If at least one of the two verifications has failed, then the verification result is “KO”.

The following paragraphs describe certain examples of implementing exemplary embodiments of the disclosure with specific signature algorithms.

### 2. “Chameleon Signature” Based Embodiments

### 2.1 General Principle of Chameleon Signature Scheme

A “chameleon” signature scheme uses a chameleon hash function and a “conventional” (RSA, DSA, . . . ) signature scheme.

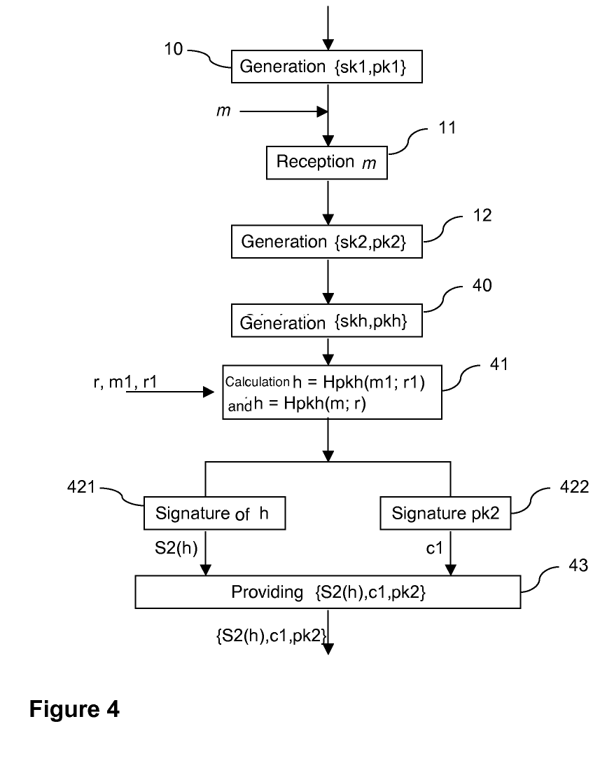

In such a signature scheme according to this embodiment of the disclosure, shown by FIG. 4, there is considered to be a signatory SS, which implements signature algorithms S1 and S2, and a verification device VV, which implements verification algorithms V1 and V2. This verification device VV likewise includes a key generation algorithm Kh. The signature scheme further includes key generation algorithms K1 and K2, generating a pair of public pk1 and private sk1 keys and a pair of public ephemeral pk2 and private sk2 keys, respectively, as already described above.

The principle of such a signature scheme is based on the application of a chameleon hash function to the message m to be signed, thereby delivering a fingerprint h of the message m, and then on the signature of this fingerprint h by the signature algorithm S1.

A chameleon hash function, as described in particular in the document “H. Krawczyk and T. Rabin. Chameleon Hashing and Signatures. 2000 Symposium on Network and Distributed System Security Symposium (NDSS '00), February 2000”, can be viewed as a single-use signature: the chameleon function H uses a public key pkh to calculate the fingerprint h=Hpkh(m; r), where m is a message to be signed and r is a random variable. A secret key skh is associated with the public key pkh. These two keys pkh and skh are generated by an algorithm Kh of the verification device VV. The latter therefore has knowledge of skh.

The properties of a chameleon function are as follows:
collision resistance (i.e., two distinct messages must have very little chance of producing the same signature): given the public key pkh, it is difficult to find a pair (m1; r1) different from a pair (m2; r2) such that Hpkh(m1; r1)=Hpkh(m2; r2);
uniformity: given secret trapdoor information skh, it is easy, given a pair (m1; r1) and m2, to calculate an r2 such that Hpkh(m1; r1)=Hpkh(m2; r2).

In a first phase, the key generation algorithm Kh of the chameleon function generates the secret skh and public pkh keys during a step 40, which follows steps 10, 11 and 12 already described in connection with FIG. 1.

Next, during a step 41, the signatory SS selects a random message m1, and a random variable r1, and, by applying the hash function, calculates the fingerprint h=Hpkh(m1; r1).

When the signatory SS receives the message to be signed, it constructs the number r using the secret key skh and the pair (m1; r1), such that h=Hpkh(m1; r1)=Hpkh(m; r).

During a step 421, using the signature algorithm S2, it likewise calculates the signature sigh2 of the fingerprint h, such that sigh2=S2(h), and by using the private key sk2, which is immediately erased, as indicated previously in the general principle.

The signature of the message m corresponds here to a triplet (m, r, sigh2). This signature can be verified by the verification algorithm VV, owing to the relationship h=Hpkh(m; r), and by means of the public keys pkh and pk2.

During a step 422, the signatory SS likewise calculates the certificate c1=S1(pk2, sk1), using the algorithm S1 and the permanent private key sk1.

The strengthened signature according to this embodiment of the disclosure therefore consists of a triplet (c1, pk2, sigh2), which is provided during a step 43, for verification purposes.

The verification device receives this triplet, thereby enabling same, during a first phase, to verify the validity of the signature c1 (using the verification algorithm V1 and the public keys pk1 and pk2). The random number r, constructed by the signatory SS, is likewise transmitted to the verification device, enabling same, in a second phase, to verify the validity of sigh2 (using the verification algorithm S2, the message m and the public keys pkh and pk2).

Thus, the objective of an exemplary aspect of disclosure is to strengthen the proposed construct by including the public key partially or totally in the hashed portion of the message to be signed. According to this embodiment, at least one of the two signature algorithms {K, S, V} used in the inventive method would be modified in the following way.

The key generation device K enables key pairs {pk, sk} to be generated, such that the public key pk is mathematically linked to the secret key.

The signature device S has two inputs, which, on the one hand, correspond to the message to be signed m, and, on the other hand, to the secret key sk, and one output, which corresponds to the signature of the message m, referenced as s=S(h(m, pk), sk), which is generated by means of the secret key sk, with h a hash function.

The verification device V has three inputs, corresponding to the hashed portion of the signed message m and public key, to the signature s generated by the signature device and to the public key pk, and one binary output b=V(h(m, pk), s, pk) (b assuming the value “true” or the value “false”). b corresponds to a validation or non-validation of the signature s of the message m by means of the public key pk.

Chameleon hash function-based exemplary embodiments of the disclosure are presented hereinbelow.

### 2.2 Example of a Discrete Logarithm Problem-Based Chameleon Hash Function

The article “H. Krawczyk and T. Rabin. Chameleon Hashing and Signatures. 2000 Symposium on Network and Distributed System Security Symposium (NDSS '00), February 2000” in particular describes such a hash function.

The following parameters must be used:
prime numbers p and q such that p=kq+1, with q being a sufficiently large prime number;
an element g, of order q in Zp* (i.e., it is a generator of the group G=<g> of order q);
the private key sk=x is a random number chosen from Zq*, and
the public key pk=y is defined by y=g^{X} mod p.

According to this embodiment, the chameleon hash function, for a message m belonging to Zq* and a random number r belonging to Zq*, is defined as follows: h=Hpk(m; r)=g^{m}.y^{r} mod p.

This hash function has perfect uniformity, because y is also a generator. As a matter of fact, even if it is clear that a collision enables the discrete logarithm problem of y to the base g to be solved, given the discrete logarithm x, the fingerprint h=h^{m1}.y^{r1}, and a message m2, it is likewise clear that r2=r1+(m1−m2)/x mod q means that Hpk(m1; r1)=Hpk(m2; r2). Thus, y^{r} “hides” m perfectly, for a random r.

### 2.3 Example of an RSA Logarithm Problem-Based Chameleon Hash Function

Consider an RSA system as described in the article “Rivest, R.; A. Shamir; L. Adleman (1978). “A method for Obtaining Digital Signatures and Public-Key Cryptosystems”. Communications of the ACM 21 (2): 120-126.”, having a public module n and a public exponent e.

The secret and public keys are sk=x, chosen randomly from Zn*, and pk=y=x^{e} mod n, respectively.

The hash function is defined by h=Hpk(m; r)=m^{e}.y^{r} mod n.

A collision means that h=m1^{e}.y^{r1}=m2^{e}.y^{r2}, which induces y^{(r2-r1)}=(m1/m2)^{e} mod n.

If (r2-r1) is co-prime with e, then it becomes possible to calculate the e^{th} root of y. Thus, e=n must be fixed.

### 3. Embodiment Based on the GHR Signature System

Such a signature system is, in particular, described in the article “R. Gennaro, S. Halevi and T. Rabin, Secure hash-and-sign signatures without the random oracle, proceedings of Eurocrypt '99, LNCS vol. 1592, Springer-Verlag, 1999, pp. 123-139”.

In this embodiment, the key generation device KK generates a strong RSA module n=pq and randomly selects a random variable y from Zn*. The public key pk then corresponds to the pair (n; y), and the secret key sk corresponds to the pair (p; q).

When the signatory SS receives a message m, it applies any hash function H in order to calculate the parameter e=H(m) which will be subsequently be used as an exponent.

The signature of the message m corresponds to the e^{th} root of y mod n, referenced as s. The following relationship must thus be verified: s^{e}=y mod n.

The signatory can easily calculate the signature s: as a matter of fact, it knows the parameter phi(n)=(p−1)(q−1) and can therefore calculate the element d such that the product of d per e is equal to 1 modulo phi(n). The signature s is then y^{d} mod n.

Note that, when the parameter e is not reversible (which can occur if e is even), one method of mitigating this problem can be to add a predetermined value to e (e.g., one) until the reversal condition is verified.

### 4. Structure of the Signature and Verification Devices

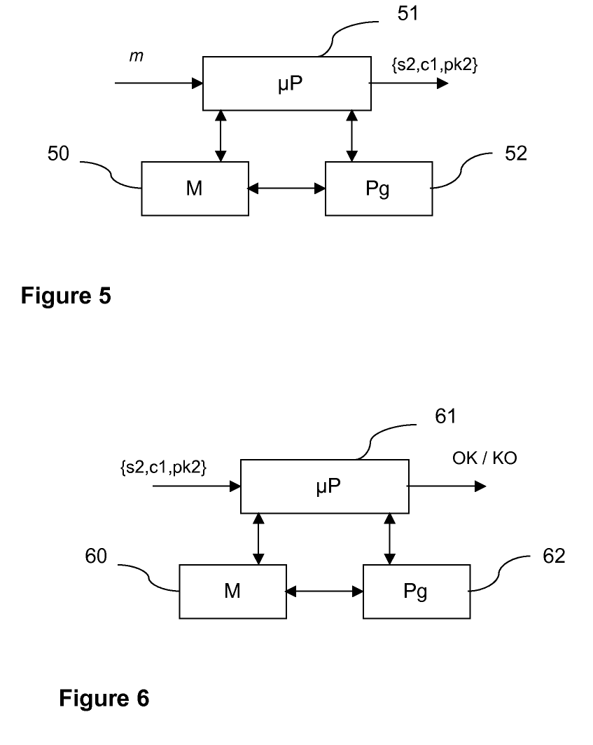

Finally, in connection with FIGS. 5 and 6, the simplified structure of a signature device and a signature verification device are presented, which implement a signature technique and a signature verification technique, respectively, in accordance with one embodiment of the disclosure.

Such a signature device includes a memory 51 consisting of a buffer memory, a processing unit 52, which, for example, is equipped with a microprocessor μP, and driven by the computer program 53, which implements the signature method according to the disclosure.

Upon initialisation, the computer program code instructions 53 are, for example, loaded into a RAM memory prior to being executed by the processor of the processing unit 52. At least one message m to be signed is input into the processing unit 52. The microprocessor of the processing unit 52 implements the steps of the above-described signature method, according to the computer program instructions 53. To accomplish this, besides the buffer memory 51, the signature device includes permanent key generation means, signature means including means of receiving the message m to be signed, means of generating an ephemeral key pair, means of calculating the signature s2 of the message m, means of calculating the signature c1 of the public key and means of providing a strengthened signature {s2, c1, pk2}. These means are driven by the microprocessor of the processing unit 52.

The processing unit 52 therefore transmits a strengthened signature to the verification device.

Such a verification device includes a memory 61 consisting of buffer memory, a processing unit 62, which is equipped, for example, with a microprocessor μP, and which is driven by the computer program 63 implementing the verification method according to the disclosure.

Upon initialisation, the computer program code instructions 63 are, for example, loaded into a RAM memory prior to being executed by the processor of the processing unit 62. A strengthened signature generated by the above-described signature device is input into the processing unit 62. The microprocessor of the processing unit 62 implements the above-described steps of the verification method, according to the computer program instructions 63. To accomplish this, besides the buffer memory 61, the verification device includes joint signature verification means, including means of receiving the strengthened signature {s2, c1, pk2} and means of verifying the signatures s2 and c1. These means are driven by the microprocessor of the processing unit 62.

The processing unit 62 delivers a strengthened signature verification result.

An exemplary embodiment of the disclosure thus provides a technique enabling the security of digital signature systems to be strengthened effectively, reliably and inexpensively, and in a manner easy to implement.

Although the present disclosure has been described with reference to one or more examples, workers skilled in the art will recognize that changes may be made in form and detail without departing from the scope of the disclosure and/or the appended claims.

What is claimed is:

1. A cryptographic message signature method having strengthened security, comprising:
implementing two sets of signature algorithms SA1={K1, S1, V1} and SA2={K2, S2, V2}, where K1 and K2 are key generation algorithms, S1 and S2 are signature generation algorithms and V1 and V2 are signature verification algorithms, and wherein the step of implementing includes:
a step of generating permanent keys using the algorithm K1, delivering a pair of private and public keys {sk1, pk1};
and, for at least one message m to be signed:
a signature step including the following sub-steps:
receipt of said message m to be signed;
generation of an ephemeral key pair {sk2,pk2} using the algorithm K2, where sk2 is a private key and pk2 is a public key;
calculation, by the signature algorithm S2, of a signature s2 of the message m by the private key sk2;
calculation, by the signature algorithm S1, of a signature c1 of the public key pk2 by the private key sk1; and
providing the strengthened signature {s2, c1, pk2}.

2. The cryptographic message signature method having strengthened security of claim 1, wherein said signature step is implemented for each message m to be signed, or periodically according to a desired level of security.

3. The cryptographic message signature method having strengthened security of claim 1, wherein said signature algorithm S2 implements a hash function and said providing step provides at least one random number r, which is used by said hash function.

4. The cryptographic message signature method having strengthened security of claim 1, wherein the algorithms K1 and K2, S1 and S2 and/or V1 and V2 are identical in pairs.

5. The cryptographic message signature method having strengthened security of claim 1, wherein SA1 and/or SA2 include algorithms of the RSA type (for “Rivest Shamir Adleman”).

6. The cryptographic message signature method having strengthened security of claim 1, wherein SA1 and/or SA2 include algorithms of the DSA type (for “Digital Signature Algorithm”).

7. The cryptographic message signature method having strengthened security of claim 3, wherein the method includes a step of generating a pair of public and secret keys {skh, pkh} by a generation algorithm Kh implemented by one of the verification algorithms V1 or V2, and said signature step implements a hash function H, known by the verification algorithms V1 and V2, such that h=Hpkh(m; r), where r is a random number.

8. The cryptographic message signature method having strengthened security of claim 7, wherein said hash function is of the “chameleon” type.

9. The cryptographic message signature method having strengthened security of claim 8, wherein said strengthened signature corresponds to triplet (S2(h), c1, pk2).

10. A cryptographic message signature verification method having strengthened security, wherein the method comprises:
implementing two signature verification algorithms V1 and V2, and a joint verification phase for signatures generated according to the cryptographic message signature method having strengthened security according to claim 1,
said verification phase including the following steps for a signed message m to be verified:
receipt of a strengthened signature triplet {s2, c1, pk2};
verification, using said verification algorithm V2 and said public key pk2, of the signature s2 of the message m, thereby delivering a first positive or negative result;
verification, using said verification algorithm V1 and a public key pk1, of the signature c1 of the public key pk2, thereby delivering a second positive or negative result;
delivering a positive result if the first and second results are positive.

11. The cryptographic message signature verification method having strengthened security of claim 10, wherein said receiving step further includes the receipt of at least one random number r.

12. A cryptographic message signature device having strengthened security, wherein the device comprises:
means for implementing two sets of signature algorithms SA1={K1, S1, V1} and SA2={K2, S2, V2}, where K1 and K2 are key generation algorithms, S1 and S2 are signature generation algorithms and V1 and V2 are signature verification algorithms, and wherein the means for implementing comprises:
means for generating permanent keys, using the algorithm K1, thereby delivering a pair of private and public keys {sk1, pk1};
and, for at least one message m to be signed:
signature means including:
means for receiving of said message m to be signed;
means for generating of an ephemeral key pair {sk2,pk2} using the algorithm K2, where sk2 is a private key and pk2 is a public key;
means for calculating, by the signature algorithm S2, a signature s2 of the message m by the private key sk2;
means for calculating, by the signature algorithm S1, a signature c1 of the public key pk2 by the private key sk1;
means for providing the strengthened signature {s2, c1, pk2}.

13. A cryptographic message signature verification device having strengthened security, wherein the device comprises:
means for implementing two signature verification algorithms V1 and V2, and joint verification means for signatures generated by the cryptographic message signature device having strengthened security of claim 12, said means for implementing comprising, for a signed message m to be verified:
means for receiving a strengthened signature triplet {s2, c1, pk2}};
means for verifying the signature s2 of the message m, using said verification algorithm V2 and said public key pk2, thereby delivering a first positive or negative result;
means for verifying the signature c1 of the public key pk2, using said verification algorithm V1 and a public key pk1, thereby delivering a second positive or negative result;
means for delivering a positive result if the first and second results are positive.

14. A cryptographic message signature verification system having strengthened security, which includes a cryptographic signature device of claim 12 and a cryptographic signature verification device of claim 13.

15. A computer program product recorded on a computer readable medium and executable by a processor, wherein the product includes program code instructions for implementing a cryptographic message signature method having strengthened security, wherein the method comprises:
implementing two sets of signature algorithms SA1={K1, S1, V1} and SA2={K2, S2, V2}, where K1 and K2 are key generation algorithms, S1 and S2 are signature generation algorithms and V1 and V2 are signature verification algorithms, and wherein the step of implementing includes:
a step of generating permanent keys using the algorithm K1, delivering a pair of private and public keys {sk1, pk1};
and, for at least one message m to be signed:
a signature step including the following sub-steps:
receipt of said message m to be signed;
generation of an ephemeral key pair {sk2,pk2} using the algorithm K2, where sk2 is a private key and pk2 is a public key;
calculation, by the signature algorithm S2, of a signature s2 of the message m by the private key sk2;
calculation, by the signature algorithm S1, of a signature c1 of the public key pk2 by the private key sk1; and
providing the strengthened signature {s2, c1, pk2}.

16. A computer program product recorded on a computer readable medium and executable by a processor, wherein the product includes program code instructions for implementing a cryptographic message signature verification method having strengthened security, wherein the method comprises:
implementing two signature verification algorithms V1 and V2, and a joint verification phase for signatures generated according to cryptographic message signature method,
said verification phase including the following steps for a signed message m to be verified:
receipt of a strengthened signature triplet {s2, c1, pk2}, where pk2 is a public key, s2 is a signature of the message m using a private key sk2, c1 is a signature of public key pk2 by a private key sk1;
verification, using said verification algorithm V2 and said public key pk2, of the signature s2 of the message m, thereby delivering a first positive or negative result;
verification, using said verification algorithm V1 and a public key pk1, of the signature c1 of the public key pk2, thereby delivering a second positive or negative result;
delivering a positive result if the first and second results are positive.
